(19) United States
(12) Patent Application Publication
(10) Pub. No.: US 2016/0026981 A1
(43) Pub. Date: Jan. 28, 2016

(54) On-Demand Payroll System and Interface

(71) Applicant: ADP, LLC, Roseland, NJ (US)

(72) Inventors: Carl Rick Collins, Brooklyn, NY (US); Keith Wilson Fulton, South Orange, NJ (US); Anna Carsen, Sunnyside, NY (US); James Caldwell Ford, Orleans, MA (US)

(21) Appl. No.: 14/682,697

(22) Filed: Apr. 9, 2015

Related U.S. Application Data
(60) Provisional application No. 62/029,877, filed on Jul. 28, 2014.

(51) Int. Cl. G06Q 20/10

(52) U.S. Cl. CPC G06Q 20/102

(57) ABSTRACT

A method for managing scheduled payroll payments to employees. A computer system identifies a schedule of payments to an employee. The computer system displays schedule in a graphical user interface on a display system in the computer system. The computer system receives user input through the graphical user interface specifying a request to change the schedule for a portion of the payments. The computer system changes the schedule based on the request.

### CROSS-REFERENCE TO RELATED APPLICATION

This application claims the benefit of priority to U.S. Provisional Patent Application No. 62/029,877, filed Jul. 28, 2014, and entitled “On-Demand Payment Management.

### BACKGROUND INFORMATION

1. Field

The present disclosure relates generally to an improved data processing system. In particular, the present disclosure relates to a method and apparatus for visualizing payroll schedules within an organization. Still more particularly, the present disclosure relates to a method and apparatus for a graphical user interface used in visualizing and managing on-demand payments for employees of an organization.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an employee information system. As yet another example, an information system may be used to determine when to hire new employees, assign employees to projects, perform reviews for employees, and other suitable operations for the organization.

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Later, these calculations were performed with the assistance of adding machines, calculators, and, finally, computers. Over time, automated systems have been developed to calculate pay, produce payroll checks, and even to make the automatic payroll deposits into an employee's bank account for employees participating in a direct deposit program.

Current payroll systems operate on a set payroll schedule, paying out compensation to employees on predetermined paydays. Employees may sometimes require cash in between payment periods for emergencies or during certain times of the year, such as holidays, and may not be able to wait until the end of the pay period. Current payroll systems Require a human resources department to respond to requests for certain payroll events.

Therefore, it would be desirable to have a method and apparatus that take into account at least some of the issues discussed above, as well as other possible issues. For example, it would be desirable to have a method and apparatus that overcome issues with comprehending information in records for people in a database.

### SUMMARY

In one illustrative embodiment, a method for managing scheduled payroll payments to employees is presented. A computer system identifies a schedule of payments to an employee. The computer system displays the schedule. The computer system receives user input specifying a request to change the schedule for a portion of the payment. Based on the request, the computer system then changes the schedule for the portion of payments.

In another illustrative embodiment, a graphical display system comprises a computer system and a payroll management system that manages scheduled payroll payments to employees. The payroll management system identifies a schedule of payments to an employee. The payroll management system displays the schedule. The payroll management system receives user input specifying a request to change the schedule for a portion of the payment. Based on the request, the payroll management system then changes the schedule for the portion of payments.

In another illustrative embodiment, a computer program product computer for managing scheduled payroll payments to employees within a payroll management system comprises a computer readable storage media, and program code stored on the computer readable storage media. The program code instructs the payroll management system to identify a schedule of payments to an employee. The program code instructs the payroll management system to display the schedule. The program code instructs the payroll management system to receive user input specifying a request to change the schedule for a portion of the payment. The program code instructs the payroll management system to change the schedule for the portion of payments based on the request.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a payroll management environment depicted in accordance with an illustrative embodiment;

FIG. 2 is an illustration of a first exemplary graphical user interface for employee interaction with the payroll management system, depicted in accordance with an illustrative embodiment;

FIG. 3 is an illustration of a second exemplary graphical user interface for employee interaction with the payroll management system, depicted in accordance with an illustrative embodiment;

FIG. 4 is an illustration of a flowchart of a process for receiving a request within a graphical user interface for the disbursement of compensation, depicted according to an illustrative embodiment;

FIG. 5 is an illustration of a flowchart of a process for determining whether to make the requested disbursement, depicted according to an illustrative embodiment; and

FIG. 6 is an illustration of a block diagram of a data processing system, depicted in accordance with an illustrative embodiment.

### DETAILED DESCRIPTION

The illustrative embodiments recognize and take into account one or more different considerations. For example, the different illustrative embodiments recognize and take into account that current systems and methods of managing employee payroll may be limited in various ways. For example, employees may sometimes require cash in between payment periods for emergencies or during certain times of the year, such as holidays, and may not be able to wait until the end of the pay period.

The illustrative embodiments recognize and take into account that, as employees earn compensation based on performing tasks and/or responsibilities for an employer, that compensation sits idle in the employer's payroll account until the next scheduled payday according to the payroll schedule. Despite having earned the compensation, employees are not able to access or utilize the earned compensation until receiving a disbursement on the next payday, according to the payroll schedule.

The illustrative embodiments recognize and take into account that clumsy, inflexible human resource obstacles issue paychecks according to the predefined payroll schedule. For example, human resource departments are usually unable to adjust earnings for requests which occur at non-uniform times.

Thus, the illustrative embodiments provide a platform that bypasses the need for clumsy, inflexible HR obstacles by creating an on-demand payment platform. The platform avoids an overly robust human resource department by allowing a user to initiate certain tasks traditionally reserved for the human resource department, such as requesting changes to a paycheck. Human resource departments likewise are usually unable to adjust earnings for requests which occur at non-uniform times. The platform allows individuals to conduct several non-uniform transactions at the same time without over-burdening individuals with having to make several complicated calculations which may be personalized based on the individual requesting the calculation.

On-demand payment management may enable a worker to be paid a pro-rata portion of earnings, for example, earned payments, benefits, draw, commission, salary and the like, earned prior to a preconfigured payment date. By tracking the number of hours, shifts, days, or other metrics, that a worker has performed, the worker's corresponding accumulated earnings over that time may be determined. The tracked time may then be used to determine a corresponding payment for the worker's earnings. When a worker opts for early payment, the corresponding accumulated earnings and/or determined corresponding payment may be used as a basis for conducting an early payment transaction. The payment may then be transferred to a worker's direct deposit account. Any earnings accrued during a current pay period beyond an early payment amount may be provided to the worker at the current pay period pay date or may be transferred to the worker during a subsequent pay period. A transaction fee may be collected for a worker opting to obtain an early payment. Access to early payments may be restricted for a variety of reasons such as, but not limited to, an employee's status in the organization, taking an early payment too many times, or if the worker's performance is poor. The on-demand payment methods and systems described herein may be used to facilitate set up of multiple payment days during a pay period prior to a predefined pay day for the pay period. For organizations with monthly or bi-monthly pay dates, on-demand payments may be particularly useful for individuals working for those organizations that need cash immediately.

In addition to providing access to accrued earnings, the on-demand payment platform may facilitate access to anticipated earnings, such as in the form of accessing an advance on the anticipated earnings. Access to such an advance on earnings may be restricted for various reasons, including worker schedule, worker union affiliation, worker position in the organization, tenure, prior use of advances, lack of accrued vacation or personal time, and the like. In an example of advancing payment for anticipated earnings, a salaried worker may have an agreement to provide certain work services (e.g. 40 hours per week) for a monthly salary. With only one week left to the end of a month, the worker may request that his accumulated earnings and his anticipated earnings for the remaining week be paid out in advance. For workers that may not be salaries, such as hourly workers, commission-based workers, and the like, an advance on anticipated earnings may be provided. For such workers, or for any type of worker, collateral may be required to take an advance on anticipated earnings. Collateral may include accrued vacation time, personal time, unused benefits, profit sharing accruals, stock options, traditional collateral, such as property, and the like. In an example of collateral-based advance on anticipated earnings, an employee may have accrued 10 days of vacation and may wish to receive an advance for 5 anticipated days of future earnings. The employee may commit to temporarily deducting 5 vacation days from her accrued 10 vacation days as collateral for the advance payment. When the employee has satisfied her working obligation for the advance of 5 days' pay, her vacation accrual may be credited back the 5 days.

The platform may also be integrated with a user interface specifically designed to facilitate the on demand compensation payments. The user interface may display how much money the worker has earned during a particular pay period. The interface may also display the percentage of the payment that the worker has earned. The interface may also enable a single-click request of a partial payment. In embodiments, the graphical representation of the worker's fractional earnings may be varied, along with other functional elements of the user interface. The interface may be utilized to facilitate the establishment of a platform payment card account. The interface may also be utilized to facilitate various remittance services that the worker has chosen to use. The interface may be used to manage a worker's preferences such as the frequencies of payments. The user interface may also be used for loan services as well. The user interface may be used to provide payment details for the loans, such as, but not limited to, an individual's bank account or credit card.”

Thus, the illustrative embodiments provide a method and apparatus for managing scheduled payroll payments to employees as part of an payroll management system. In one example, a process for managing scheduled payroll payments to employees is presented. The process identifies, by a computer system, a schedule of payments to an employee. The process displays, by a computer system, the schedule. The process receives, by a computer system, user input specifying a request to change the schedule for a portion of the payments. The process changes, by a computer system, the schedule based on the request.

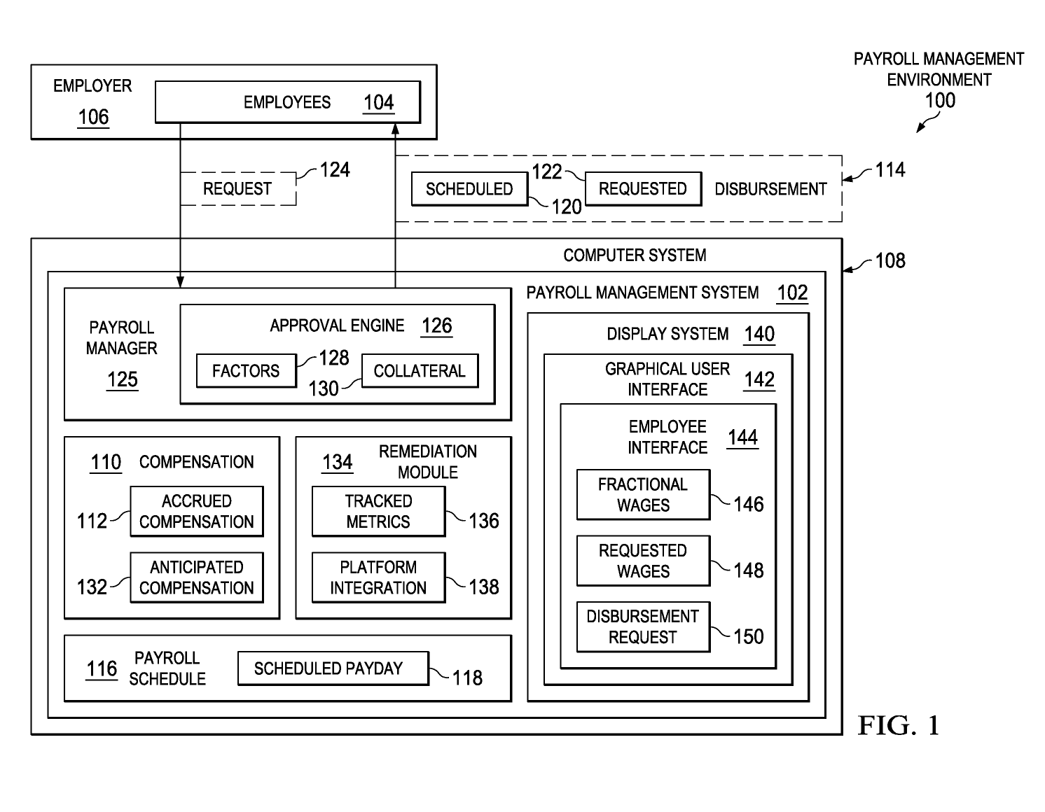

With reference now to the Figures and in particular with reference to FIG. 1, an illustration of a block diagram of a payroll management environment is depicted in accordance with an illustrative embodiment. Payroll management environment 100 includes payroll management system 102. Payroll management system 102 is used to perform operations with respect to employees 104. The operations can be, for example but not limited to, at least one of recommending, scheduling, monitoring, and evaluating activities to be performed by employees 104. As depicted, employees 104 are people who are employed by or associated with an entity for which payroll management system 102 is implemented, such as employer 106.

Payroll management system 102 can be implemented in computer system 108, where the computer system is a hardware system includes one or more data processing systems. When more than one data processing system is present, those data processing systems may be in communication with each other using a communications medium. The communications medium may be a network. The data processing systems may be selected from at least one of a computer, a workstation, a server computer, a tablet computer, a laptop computer, a mobile phone, a personal digital assistant (PDA), or some other suitable data processing system.

Employees 104 earn compensation 110 by performing various duties and responsibilities based on their employment with employer 106. As used herein, compensation 110 can be at least one of wages, salaries, monetary compensations, and remuneration paid by employer 106 to employees 104 in exchange for work done as part of an employment contract. Compensation 110 may be calculated as a fixed amount for each task completed, or at an hourly or daily rate, or based on an easily measured quantity of work done. Compensation 110 can also be a salary paid periodically from employer 106 to employees 104.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As employees 104 perform duties and responsibilities for employer 106, compensation 110 accumulates as accrued compensation 112 before it is disbursed to employees 104. Accrued compensation 112 is compensation 110 earned by employees 104, but not yet paid out as disbursements 114.

Disbursements 114 are payments of compensation 110 to employees 104. Disbursements 114 can include at least one of all of accrued compensation 112, or a portion of accrued compensation 112.

Payroll management system 102 includes payroll schedule 116. Payroll schedule 116 is a predetermined schedule delimiting scheduled paydays 118 on which employer 106 makes scheduled disbursements 120 to employees 104. scheduled paydays 118 are predetermined days on which employer 106 makes scheduled disbursements 120 to employees 104. Scheduled disbursements 120 are disbursements 114 that occur on scheduled paydays 118 according to payroll schedule 116.

The illustrative embodiments described here in recognize and take into account that employees 104 may sometimes require cash in between scheduled paydays 118 for emergencies or during certain times of the year, such as holidays. In these situations, employees 104 and may not be fiscally able to wait to receive scheduled disbursements 120 according to payroll schedule 116. Payroll management system 102 provides an on-demand payment platform for accrued compensation 112 that allows employees 104 to optionally receive requested disbursement 122 between scheduled paydays 118.

Requested disbursements 122 are disbursements 114 that occur in response to requests 124 from employees 104. Requested disbursement 122 are not scheduled disbursements 120 that occur periodically on scheduled paydays 118 according to payroll schedule 116. Requested disbursement 122 may include accrued, unpaid earnings for a partial pay period, and it may also include receiving earnings for a period that has not yet occurred, but for which there is a high likelihood of earnings being received. According to an illustrative embodiment, requested disbursement 122 can be for at least one of all of accrued compensation 112, or a portion of accrued compensation 112.

Payroll management system 102 includes payroll manager 125 to facilitate on-demand payments of requested disbursement 122 to employees 104. Payroll manager 125 therefore facilitates the processing and payment of requested disbursements 122 that occur outside of scheduled paydays 118 according to payroll schedule 116.

Payroll manager 125 may be implemented in software, hardware, firmware or a combination thereof. When software is used, the operations performed by payroll manager 125 may be implemented in program code configured to run on hardware, such as a processor unit. When firmware is used, the operations performed by payroll manager 125 may be implemented in program code and data and stored in persistent memory to run on a processor unit. When hardware is employed, the hardware may include circuits that operate to perform the operations in payroll manager 125.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

According to an illustrative embodiment, payroll manager 125 includes approval engine 126. Approval engine 126 determines whether to make requested disbursement 122 based on the application of factors 128 and collateral 130.

Factors 128 are the criteria and circumstances that payroll manager 125 takes into account in determining whether to make requested disbursement 122. Factors 128 can include, for example but not limited to, at least one of a role of employees 104 within for employer 106, a position of employees 104 within employer 106, an current employment status of employees 104 in employer 106, a work history of employees 104 for employer 106, an performance review of employees 104, and a number of times employer one employees 104 has submitted a request 124 for requested disbursement 122. Factors 128 can further include, for example but not limited to, at least one of privileges earned by employees 104 as rewards for good performance, seniority of employees 104 within employer 106, and morale of employees 104. Factors 128 can further include, for example but not limited to, a work schedule of employees 104, worker union affiliation of employees 104, a tenure of employees 104, an amount of accrued vacation by employees 104, and an amount of accrued personal time by employees 104.

Collateral 130 is security place by employees 104 for accessing and receiving the requested disbursement 122. Collateral 130 may take the form of monetary collateral or nonmonetary collateral. Collateral 130 can include, but is not limited to, at least one of a portion of future earnings, a portion of a future bonus, or an up-front fee. Therefore, in exchange for receiving requested disbursement 122, employees 104 may undertake various monetary actions, such as at least one of giving up a portion of their total earnings for the pay period, paying a fee or for different/additional consideration, and paying interest.

Non-monetary forms of collateral may include stock options, health benefits, and vacation days. In exchange for receiving requested disbursement 122, employees 104 may undertake various non-monetary actions, such as accepting new or different job responsibilities (e.g., agreeing to take a less desirable shift, such as during a holiday weekend), or the like.

Approval engine 126 applies factors 128 and collateral 130 to facilitate a determination by payroll manager 125 whether to make requested disbursement 122 to employees 104. According to an illustrative embodiment, payroll manager 125 determines whether to make the requested disbursement 122 of accrued compensation 112.

For example, in an illustrative embodiment, one of employees 104 may have an agreement with the employer 106 to provide certain work services for compensation 110 to be paid on scheduled payday 118 according to payroll schedule 116. According to the illustrative example, payroll schedule 116 is a monthly schedule, with employees 104 receiving compensation 110 once per month according to payroll schedule 116. With only one week left to the end of a month, employee 104 may make request 124 that accrued compensation 112 be paid out in advance of the scheduled payday 118. Approval engine 126 applies factors 128 and collateral 130 to facilitate a determination by payroll manager 125 whether to make requested disbursement 122 of accrued compensation 112 to employees 104.

Compensation 110 may also include anticipated compensation 132. Anticipated compensation 132 is compensation 110 that has not yet been earned by employees 104, but is expected to be earned prior to, and paid out on scheduled payday 118 according to payroll schedule 116. According to an illustrative embodiment, requested disbursement 122 can be for all of accrued compensation 112, and at least one of a portion of anticipated compensation 132 and all of anticipated compensation 132.

Approval engine 126 applies factors 128 and collateral 130 to facilitate a determination by payroll manager 125 whether to make requested disbursement 122 to employees 104. According to an illustrative embodiment, payroll manager 125 determines whether to make the requested disbursement 122 of anticipated compensation 132.

For example, in an illustrative embodiment, one of employees 104 may have an agreement with the employer 106 to provide certain work services for compensation 110 to be paid on scheduled payday 118 according to payroll schedule 116. According to the illustrative example, payroll schedule 116 is a monthly schedule, with employees 104 receiving compensation 110 once per month according to payroll schedule 116. With only one week left to the end of a month, employee 104 may make request 124 that both accrued compensation 112 and anticipated compensation 132 be paid out in advance of the scheduled payday 118. Approval engine 126 applies factors 128 and collateral 130 to facilitate a determination by payroll manager 125 whether to make requested disbursement 122 of accrued compensation 112 and anticipated compensation 132 to employees 104.

According to an illustrative embodiment, approval engine 126 may require collateral 130 before approving requested disbursement 122 of at least one of accrued compensation 112 or anticipated compensation 132 to employees 104. In one illustrative embodiment, employees 104 may commit to temporarily deducting a number of accrued vacation days as collateral 130 for requested disbursement 122. The number of accrued vacation days may be equal to a number of days until a next one of scheduled payday 118. The number of accrued vacation days may be credited back to employee 104 on the next one of scheduled payday 118.

Payroll management system 102 includes remediation module 134. Remediation module 134 collects and tracks tracked metrics 136 as part of payroll management system 102. Tracked metrics 136 can include data related to request 124, such as but not limited to at least one of a date that request 124 is submitted, a frequency that employees 104 submit request 124, an amount of accrued compensation 112 requested by request 124, and an amount of anticipated compensation 132 requested by request 124.

Payroll management system 102 may analyze tracked metrics 136 to determine a financial status of employees 104. The financial status can include, for example at least one of, such as fiscal habits of employees 104, fiscal state of mind of employees 104, financial preferences of employees 104, and financial obligations of employees 104, and the like.

For example, according to an illustrative embodiment, remediation module 134 may be used to identify employees 104 that consistently take payment advances. This data may indicate that a particular one of employees 104 is struggling financially. Based on tracked metrics 136, Remediation module 134 may provide recommendations to remediate a solution. These recommendations may be provided by platform integration 138 to other work management platforms based on the analysis.

Similarly, platform integration 138 may associate data provided from other work management platforms with tracked metrics 136. For example, platform integration 138 may associate data from other platforms, such as at least one of data relating to hours worked, data relating to compensation, data relating to work performance, data relating to accomplishment of goals, data relating to unmet goals, data relating to the employee's work group, data relating to a co-worker, and data relating to a supervisor.

In an illustrative embodiment, platform integration 138 can provide an exemplary recommendation to a scheduling platform to recommend providing more work shifts for employees 104 submitting request 124. Employer 106 may utilize tracked metrics 136 provided by platform integration 138 to evaluate and optimize payroll schedule 116. For example, employer 106 can utilize tracked metrics 136 to assess whether an employer 106 should adopt more frequent scheduled paydays 118.

Employer 106 may utilize tracked metrics 136 provided by platform integration 138 to assess certain times of the year when employees 104 are more frequently submitting request 124. Such a determination may indicate that employees 104 are stressed about their ability to meet their financial obligations. This determination may lead employer 106 to increase compensation or provide other rewards or incentives to offset stress of employees 104.

Platform integration 138 may be integrated with other platforms, such as ones handling offers and benefits, including loan consolidation offers, payment plan offers, savings plan offers, layaway offers, discount offers (including volume discount offers) and the like. According to an illustrative embodiment, recommendations provided by remediation module 134 may be triggered based on usage activity. For example, offers to consolidate credit might be presented at the time employees 104 typically submit request 124.

Platform integration 138 may also be integrated with bill payment platforms, so that employees 104 can manage incoming and outgoing payments in the same interface, such as setting up an advance pay check and directing payment contemporaneously to a particular “pay to” account. Thus, employees 104 may ensure that critical bills (e.g., utilities) are paid on time, notwithstanding the timing of a scheduled payday 118 according to payroll schedule 116.

Platform integration 138 may be integrated with financial data about employees 104, such as data from credit reporting agencies or the like, to determine whether the employee 104 is in an “at risk” category. Remediation module 134 may make suggestions to Employees 104 in an “at risk” category, such as work more suited to their capabilities, work that offers more incentive compensation opportunities, or counseling, including financial management and/or credit counseling.

In an illustrative embodiment, platform integration 138 can communicate tracked metrics 136 to a learning engine, such as a machine learning engine, to learn patterns of usage with respect to a user. The machine learning engine may be fed goals, or objective functions, such as related to reducing the reliance of employees 104 on the usage of payroll management system 102. Remediation module 134 can initiate various suggestions, messages and recommendations to employees 104, then track the responses against such a goal or metric, to provide the most helpful or relevant recommendations or actions. For example, the engine might learn that presenting particular types of work (e.g., extra shifts) at particular points in time (e.g., immediately before pay day) has the greatest impact on an objective or metric, such a goal relating to at least one of increasing the income or wealth of employees 104, increasing the productivity of employees 104, and increasing the financial success of the employer 106.

As depicted, payroll management system 102 includes display system 140. In this illustrative example, display system 140 can be a group of display devices. A display device in display system 140 may be selected from one of a liquid crystal display (LCD), a light emitting diode (LED) display, an organic light emitting diode (OLED) display, and other suitable types of display devices.

In this illustrative example, display system 140 includes graphical user interface 142. graphical user interface 142 is an interface that allows users to interact with payroll management system 102 through graphical icons and visual indicators

In this illustrative example, graphical user interface 142 includes employee interface 144 Employee interface 144 is an interface through which employees 104 can interact with payroll management system 102. In this illustrative example, payroll management system 102 can display information such as for example, at least one of fractional wages 146, requested wages 148, disbursement request 150, or other suitable information.

According to an illustrative embodiment, employee interface 144 may also include user interface features that are customized based on tracked metrics 136. For example, if employees 104 consistently takes out the same amount of at least one of accrued compensation 112 and anticipated compensation 132 on the same day each month, payroll management system 102 could alter employee interface 144 to include a “one click” option to withdraw that amount, facilitating a quicker submission of request 124.

Alternatively, remediation module 134 could alter employee interface 144 to provide an opportunity to sign up for a work opportunity, such as an extra shift, with a calendar invitation, button, icon, or the like. Employees 104 could accept the additional shift directly from employee interface 144, as advance payment options are being presented or acted upon. Employee interface 144 may also present alternatives, such as suggesting that the employee take a lower amount of at least one of accrued compensation 112 and anticipated compensation 132, and sign up for an extra shift before scheduled payday 118.

As a result, computer system 108 operates as a special purpose computer system in which payroll manager 125 in computer system 108 enables a worker to be paid a pro-rata portion of earnings, for example, earned payments, benefits, draw, commission, salary and the like, earned prior to a preconfigured payment date, as part of a payroll management system. By tracking the number of hours, shifts, days, or other metrics, that a worker has performed, payroll manager 125 determines the worker's corresponding accumulated earnings over that time. Payroll manager 125 may then use the tracked time to determine a corresponding payment for the worker's earnings. Payroll manager 125 avoids an overly robust human resource department by allowing a user to initiate certain tasks traditionally reserved for the human resource department, such as requesting changes to a paycheck. Payroll manager 125 enables personalization of recommended activities by identifying an employee's health factors and preferences.

Payroll manager 125 enables a customizable approach to scheduled payroll payments to employees as part of a payroll management system. Thus, payroll manager 125 transforms computer system 108 into a special purpose computer system as compared to currently available general computer systems that do not have wellness manager 129.

The illustration of payroll management system 102 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, wellness manager 129 may be used to track employee activities as part of a calendar system. As another illustrative example, changes to employee preferences can be displayed and manipulated for single employees as well as groups of employees.

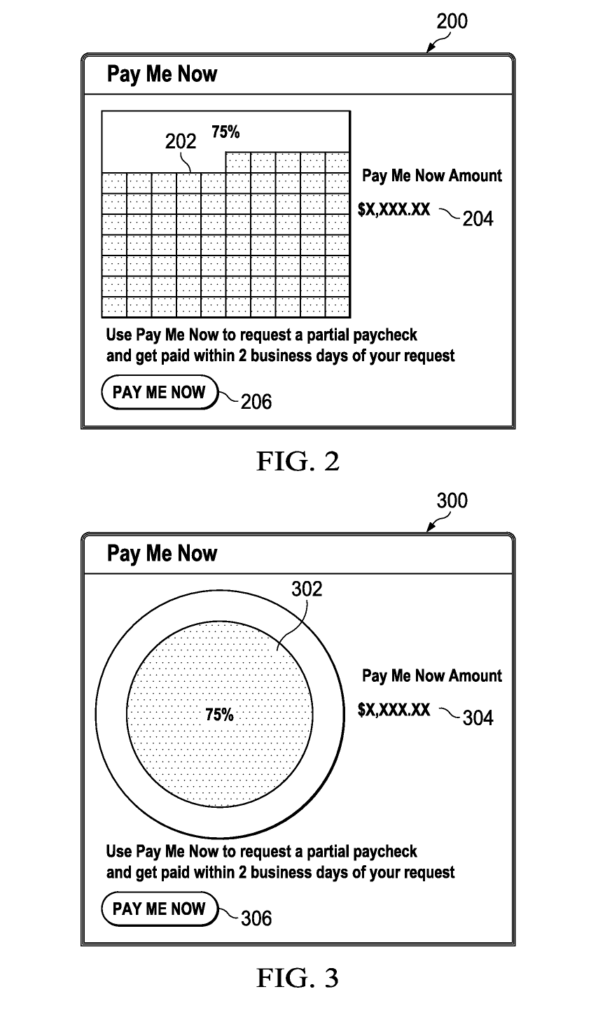

With reference next to FIG. 2, an illustration of a first exemplary graphical user interface for employee interaction with a payroll management system is depicted in accordance with an illustrative embodiment. As depicted, employee interface 200 is an example of employee interface 144 of graphical user interface 142 in FIG. 1.

As depicted, employee interface 200 can display at least one of fractional wages 202, requested wages 204, disbursement request 206.

Fractional wages 202 is an example of fractional wages 146 of FIG. 1. As depicted, fractional wages 202 is a graphic representation showing an amount of accrued compensation 112 in relation to a sum of accrued compensation 112 and anticipated compensation 132 that is expected to be included in scheduled disbursement 120 employees 104 on scheduled payday 118. According to an illustrative embodiment, fractional wages 202 represents the amount of accrued compensation 112 that is available to employees 104 by way of requested disbursement 122.

Requested wages 204 is an example of requested wages 148 of FIG. 1. As depicted, requested wages 204 is a graphic representation showing an amount of compensation 110 requested by that employees 104 in requested disbursement 122. According to an illustrative embodiment, requested wages 204 can include at least one of a portion of accrued compensation 112, a total of accrued compensation 112, a portion of anticipated compensation 132, and a total of anticipated compensation 132.

Disbursement request 206 is an example of disbursement request 150 of FIG. 1. As depicted, disbursement request 206 is an icon or hyperlink that allows employees 104 to interact with a payroll management system 102 by submitting request 124 to payroll manager 125.

With reference next to FIG. 3, an illustration of a second exemplary graphical user interface for employee interaction with a payroll management system is depicted in accordance with an illustrative embodiment. As depicted, employee interface 300 is an example of employee interface 144 of graphical user interface 142 in FIG. 1.

As depicted, employee interface 300 can display at least one of fractional wages 302, requested wages 304, disbursement request 306.

Fractional wages 302 is an example of fractional wages 146 of FIG. 1. As depicted, fractional wages 302 is a graphic representation showing an amount of accrued compensation 112 in relation to a sum of accrued compensation 112 and anticipated compensation 132 that is expected to be included in scheduled disbursement 120 employees 104 on scheduled payday 118. According to an illustrative embodiment, fractional wages 302 represents the amount of accrued compensation 112 that is available to employees 104 by way of requested disbursement 122.

Requested wages 304 is an example of requested wages 148 of FIG. 1. As depicted, requested wages 304 is a graphic representation showing an amount of compensation 110 requested by that employees 104 in requested disbursement 122. According to an illustrative embodiment, requested wages 304 can include at least one of a portion of accrued compensation 112, a total of accrued compensation 112, a portion of anticipated compensation 132, and a total of anticipated compensation 132.

Disbursement request 306 is an example of disbursement request 150 of FIG. 1. As depicted, disbursement request 306 is an icon or hyperlink that allows employees 104 to interact with a payroll management system 102 by submitting request 124 to payroll manager 125.

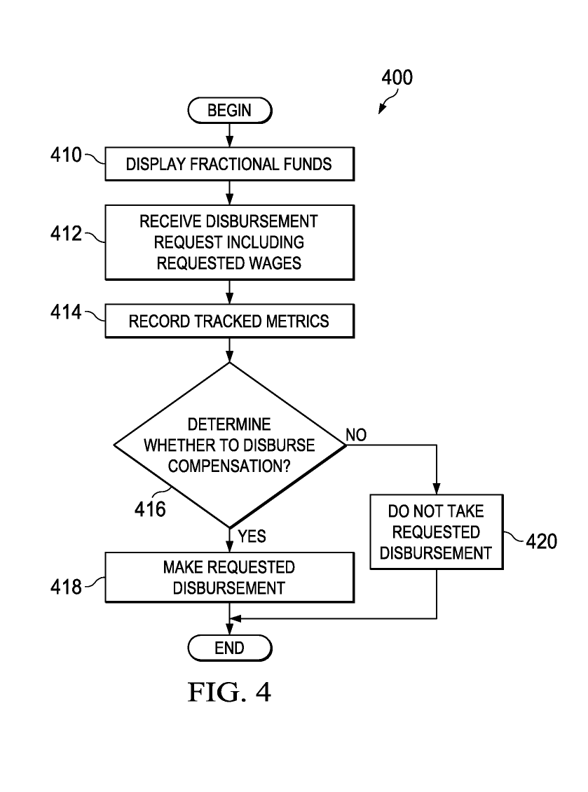

With reference now to FIG. 4, an illustration of a flowchart of a process for receiving a request for the disbursement of compensation within a graphical user interface is depicted according to an illustrative embodiment. Process 400 may be implemented in in payroll manager 125 in payroll management system 102 of payroll management environment 100 in FIG. 1.

Process 400 begins by displaying fractional wages (step 410). Fractional wages can be fractional wages 146 of FIG. 1, display as fractional wages 202 in employee interface 200 of FIG. 2 or fractional wages 302 in employee interface 300 of FIG. 3.

Process 400 then receives the disbursement request including requested wages (step 412). The disbursement request can be received based on interaction by employees 104 with disbursement request 206 displayed in employee interface 200 of FIG. 2, four disbursement request 306 displayed in employee interface 300 of FIG. 3.

In response to receiving the disbursement request, Process 400 records tracked metrics (step 414). The tracked metrics can be tracked metrics 136 of FIG. 1.

Process 400 then determines whether to make the requested disbursement (step 416). In response to determining to make the requested disbursement, process 400 makes the requested disbursement (step 418), with the process terminating thereafter. The requested disbursement can be requested disbursement 122 of FIG. 1.

Returning now to step 416, in response to determining not to make the requested disbursement, process 400 does not make the requested disbursement (step 420) with the process terminating thereafter.

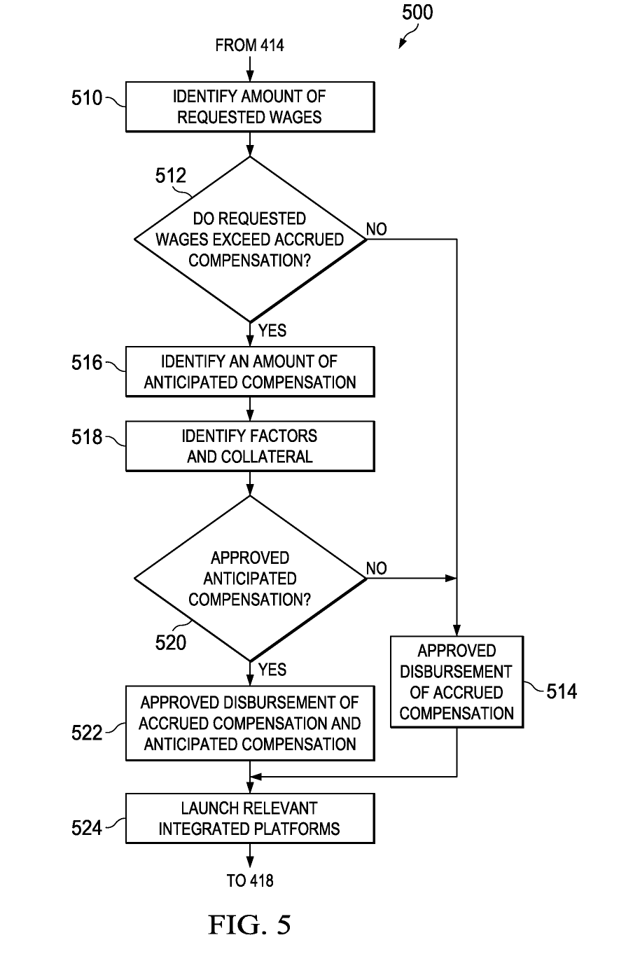

Referring now to FIG. 5, an illustration of a flowchart of a process for determining whether to make a requested disbursement is depicted according to an illustrative embodiment. Process 500 may be implemented in in payroll manager 125 in payroll management system 102 of payroll management environment 100 in FIG. 1. Process 500 is a more detailed depiction of step 416 of FIG. 4.

Process 500 identifies the amount of requested compensation (step 510). The amount of requested compensation submitted in a request, such as request 124 of FIG. 1. The amount requested compensation can be identified within an employee interface of a graphical user interface, such as from requested wages 204 in employee interface 200 of FIG. 2, or requested wages 304 in employee interface 300 of FIG. 3.

Process 500 then determines whether the requested compensation exceeds and accrued compensation (step 512). The accrued compensation can be, for example accrued compensation 112 of FIG. 1. The accrued compensation can be displayed as fractional wages 202 with an employee interface 200 of FIG. 2, or fractional wages 302 with an employee interface 300 of FIG. 3. Responsive to determining that the requested compensation does not exceed the accrued compensation, process 500 approves disbursement of the accrued compensation (step 514).

Returning now to step 512, responsive to determining that the requested compensation exceeds the accrued compensation, process 500 identifies the amount of anticipated compensation within the requested compensation (step 516). The amount of anticipated compensation can be the difference between the requested compensation and any accrued compensation. The anticipated compensation can be, for example, anticipated compensation 132 of FIG. 1.

When the requested compensation exceeds accrued compensation, the employee has requested anticipated compensation in addition to accrued compensation. Therefore, process 500 may require additional safeguards before making the requested disbursement, such as requested disbursement 122 of FIG. 1.

Responsive to identifying the amount of anticipated compensation, process 500 identifies any relevant factors and collateral relevant to determining the disbursement of the anticipated compensation (step 518). The relevant factors can be, for example, factors 128 in FIG. 1. The relevant collateral can be, for example, collateral 130 in FIG. 1.

Based on the relevant factors and collateral, process 500 and determines whether to approve disbursement of the anticipated compensation (step 520). Responsive to disbursement of the anticipated compensation being approved (“yes” at step 520), process 500 approves disbursement of the anticipated compensation and the accrued compensation (step 522). Responsive to the disbursement of anticipated competition not being approved (“no” at step 520), process 500 approves disbursement of the accrued compensation, without approving the anticipated compensation (step 514).

Process 500 can then launch any relevant integrated platforms (step 522) before continuing to step 418 of FIG. 4 to make the requested disbursement. Integrated platforms can be provided through platform integration 138 of remediation module 134 in FIG. 1.

In this manner, the illustrative embodiments provide an on-demand payment management platform that enables a worker to be paid a pro-rata portion of earnings (e.g. earned payments, benefits, draw, commission, salary and the like) earned prior to a preconfigured payment date. By tracking the number of hours, shifts, days, or other metrics, that a worker has performed, the worker's corresponding accumulated earnings over that time may be determined. The tracked time may then be used to determine a corresponding payment for the worker's earnings. When a worker opts for early payment, the corresponding accumulated earnings and/or determined corresponding payment may be used as a basis for conducting an early payment transaction. The payment may then be transferred to a worker's direct deposit account. Any earnings accrued during a current pay period beyond an early payment amount may be provided to the worker at the current pay period pay date or may be transferred to the worker during a subsequent pay period. A transaction fee may be collected for a worker opting to obtain an early payment. Access to early payments may be restricted for a variety of reasons such as, but not limited to an employee's status in the organization, taking an early payment too many times, or if the worker's performance is poor. The on-demand payment methods and systems described herein may be used to facilitate set up of multiple payment days during a pay period prior to a predefined pay day for the pay period. For organizations with monthly or bi-monthly pay dates, on-demand payments may be particularly useful for individuals working for those organizations that need cash immediately.

In addition to providing access to accrued earnings, the on-demand payment platform may facilitate access to anticipated earnings, such as in the form of accessing an advance on the anticipated earnings. Access to such an advance on earnings may be restricted for various reasons, including worker schedule, worker union affiliation, worker position in the organization, tenure, prior use of advances, lack of accrued vacation or personal time, and the like. In an example of advancing payment for anticipated earnings, a salaried worker may have an agreement to provide certain work services (e.g. 40 hours per week) for a monthly salary. With only one week left to the end of a month, the worker may request that his accumulated earnings and his anticipated earnings for the remaining week be paid out in advance. For workers that may not be salaried (e.g. hourly workers, commission-based workers, and the like), an advance on anticipated earnings may be provided. For such workers, or for any type of worker, collateral may be required to take an advance on anticipated earnings. Collateral may include accrued vacation time, personal time, unused benefits, profit sharing accruals, stock options, traditional collateral, such as property, and the like. In an example of collateral-based advance on anticipated earnings, an employee may have accrued 10 days of vacation and may wish to receive an advance for 5 anticipated days of future earnings. The employee may commit to temporarily deducting 5 vacation days from her accrued 10 vacation days as collateral for the advance payment. When the employee has satisfied her working obligation for the advance of 5 days pay, her vacation accrual may be credited back the 5 days.

The platform may also be integrated with a user interface specifically designed to facilitate the on demand compensation payments. The user interface may display how much money the worker has earned during a particular pay period. The interface may also display the percentage of the payment that the worker has earned. The interface may also enable a single-click request of a partial payment. In embodiments, the graphical representation of the worker's fractional earnings may be varied, along with other functional elements of the user interface. The interface may be utilized to facilitate the establishment of a platform payment card account. The interface may also be utilized to facilitate various remittance services that the worker has chosen to use. The interface may be used to manage a worker's preferences such as the frequencies of payments. The user interface may also be used for loan services as well. The user interface may be used to provide payment details for the loans, such as, but not limited to, an individual's bank account or credit card.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the Figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

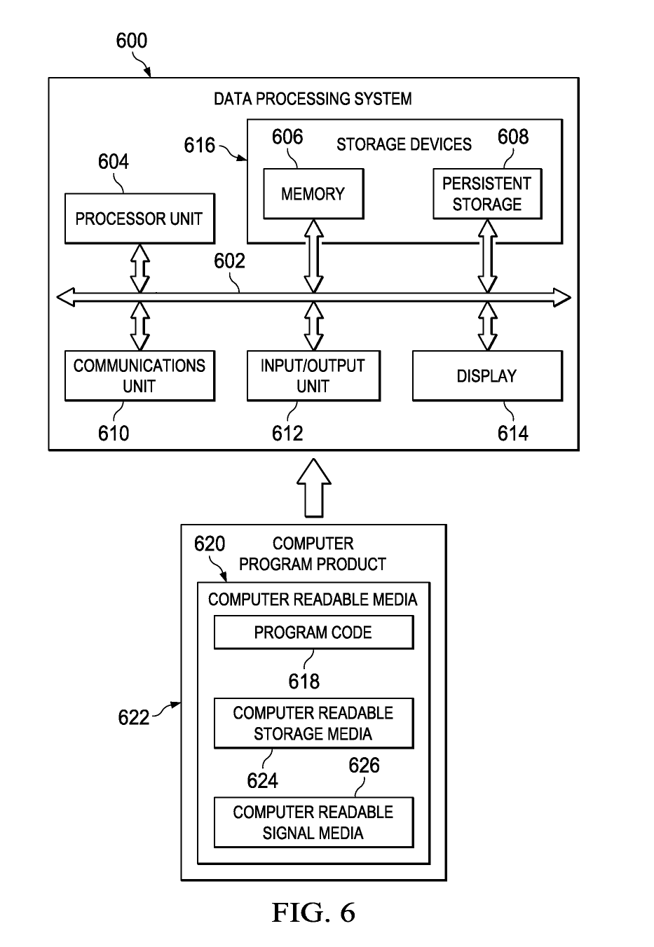

Turning now to FIG. 6, an illustration of a block diagram of a data processing system is depicted in accordance with an illustrative embodiment. Data processing system 600 may be used to implement one or more data processing systems in payroll management system 102 in FIG. 1. In this illustrative example, data processing system 600 includes communications framework 602, which provides communications between processor unit 604, memory 606, persistent storage 608, communications unit 610, input/output unit 612, and display 614. In this example, communication framework may take the form of a bus system.

Processor unit 604 serves to execute instructions for software that may be loaded into memory 606. Processor unit 604 may be a number of processors, a multi-processor core, or some other type of processor, depending on the particular implementation.

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these illustrative examples. In one example, computer readable media 620 may be computer readable storage media 624 or computer readable signal media 626.

In these illustrative examples, computer readable storage media 624 is a physical or tangible storage device used to store program code 618 rather than a medium that propagates or transmits program code 618.

Alternatively, program code 618 may be transferred to data processing system 600 using computer readable signal media 626. Computer readable signal media 626 may be, for example, a propagated data signal containing program code 618. For example, computer readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

Thus, the illustrative embodiments provide a method and apparatus for managing wellness of employees. In one illustrative example, an employee management wellness system receives a group of health factors for activities and group of preferences for activities of the employees. The wellness system identifies a recommendation for an activity for a portion of the employees based on the group health factors, the group of preferences, and information for locations where recommended activities are to occur. The wellness system then sends the recommendation for the activity to the portion of the employees.

In this manner, the recommendation, scheduling, and monitoring of activities to be performed by employees as part of a health and wellness program can be made more easily as compared to currently used techniques. Because recommended activities are specifically interesting to the employee, employee participation in the health and wellness program is encouraged. As a result, employees are more likely to take advantage of activities offered by and recommended by a health and wellness program. Furthermore, by recommending, scheduling, monitoring, and analyzing activities to be performed by employees as part of a health and wellness program, a desired level of wellness among employees is enabled.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. In particular, wellness manager is configured to perform the different operations described as well as other operations using at least one of program code, hardware, firmware, or other suitable components.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing scheduled payroll payments to employees, the method comprising:
identifying, by a computer system, a schedule of payments to an employee;
displaying, by the computer system, the schedule;
receiving, by the computer system, user input specifying a request to change the schedule for a portion of the payments; and
changing, by the computer system, the schedule based on the request.

2. The method of claim 1, wherein the change is for a portion of the pay to be sent at different times other than the scheduled times.

3. The method of claim 2, wherein the pay is selected from the group consisting of accrued compensation, anticipated compensation, and combinations thereof.

4. The method of claim 1 further comprising:
receiving, by the computer system, manager approval process for the change

5. The method of claim 1 further comprising:
determining whether to change the schedule based a set of factors.

6. The method of claim 5, wherein the set of factors is selected from the group consisting of employee performance, employee level, amount of funds, purpose of funds, funds availability determination.

7. The method of claim 3, wherein the pay comprises anticipated compensation, the method further comprising:
identifying a collateral to secure the anticipated compensation.

8. The method of claim 7, wherein the collateral comprises at least one accrued vacation day of the employee, the method further comprising:
deducting the at least one accrued vacation days.

9. The method of claim 8, further comprising:
re-crediting the at least one vacation day to the employee upon earning additional accrued compensation equal to the anticipated compensation.

10. A computer system comprising:
a display system; and
a payroll manager of a payroll management system in the computer system in communication with the display system, wherein the payroll manager identifies a schedule of payments to an employee; displays the schedule; receives user input specifying a request to change the schedule for a portion of the payments; and changes the schedule based on the request.

11. The computer system of claim 10, wherein the change is for a portion of the pay to be sent at different times other than the scheduled times.

12. The computer system of claim 11, wherein the pay is selected from the group consisting of accrued compensation, anticipated compensation, and combinations thereof.

13. The computer system of claim 10, wherein the payroll manager receives manager approval process for the change.

14. The computer system of claim 10, wherein the payroll manager determines whether to change the schedule based a set of factors.

15. The computer system of claim 14, wherein the set of factors is selected from the group consisting of employee performance, employee level, amount of funds, purpose of funds, funds availability determination.

16. The computer system of claim 12, wherein the pay comprises anticipated compensation, wherein the payroll manager identifies a collateral to secure the anticipated compensation.

17. The computer system of claim 16, wherein the collateral comprises at least one accrued vacation day of the employee, wherein the payroll manager deducts the at least one accrued vacation days.

18. The computer system of claim 17, wherein the payroll manager re-credits the at least one vacation day to the employee upon earning additional accrued compensation equal to the anticipated compensation.

19. A computer program product for managing scheduled payroll payments to employees, the computer program product comprising:
a computer readable storage media;
first program code, stored on the computer readable storage media, for identifying a schedule of payments to an employee;
second program code, stored on the computer readable storage media, for displaying the schedule;
third program code, stored on the computer readable storage media, for receiving user input specifying a request to change the schedule for a portion of the payments; and
fourth program code, stored on the computer readable storage media, for changing the schedule based on the request.

20. The computer program product of claim 19, wherein the change is for a portion of the pay to be sent at different times other than the scheduled times.

21. The computer program product of claim 20, wherein the pay is selected from the group consisting of accrued compensation, anticipated compensation, and combinations thereof.

22. The computer program product of claim 19 further comprising:
fifth program code, stored on the computer readable storage media, for receiving manager approval process for the change

23. The computer program product of claim 19 further comprising:
fifth program code, stored on the computer readable storage media, for determining whether to change the schedule based a set of factors.

24. The computer program product of claim 23, wherein the set of factors is selected from the group consisting of employee performance, employee level, amount of funds, purpose of funds, funds availability determination.

25. The computer program product of claim 21, wherein the pay comprises anticipated compensation, the computer program product further comprising:
eighth program code, stored on the computer readable storage media, for identifying a collateral to secure the anticipated compensation.

26. The computer program product of claim 25, wherein the collateral comprises at least one accrued vacation day of the employee, the computer program product further comprising:
ninth program code, stored on the computer readable storage media, for deducting the at least one accrued vacation days.

27. The computer program product of claim 26, further comprising:
tenth program code, stored on the computer readable storage media, for re-crediting the at least one vacation day to the employee upon earning additional accrued compensation equal to the anticipated compensation.
